(19) United States
(12) Patent Application Publication
(10) Pub. No.: US 2013/0156890 A1
(43) Pub. Date: Jun. 20, 2013

(54) Methods of Juice Production

(71) Applicants: Aindrila Dasgupta, Bangalore (IN); Pooja Ashok, Bangalore (IN); Hans Peter Heldt-Hansen, Virum (DK)

(72) Inventors: Aindrila Dasgupta, Bangalore (IN); Pooja Ashok, Bangalore (IN); Hans Peter Heldt-Hansen, Virum (DK)

(73) Assignee: NOVOZYMES A/S, Bagsvaerd (DK)

(21) Appl. No.: 13/820,643

(22) PCT Filed: Sep. 22, 2011
(86) PCT No.: PCT/EP11/66518

§ 371 Date: Mar. 4, 2013

(30) Foreign Application Priority Data
Sep. 23, 2010 (IN) 2773/CHE/2010

(51) Int. Cl. A23L 2/84

(52) U.S. Cl. CPC A23L 2/84
USPC 426/50

(57) ABSTRACT

The present invention describes a method of improving the mashing process in the production of clarified juice from a plant material comprising: providing a plant material; crushing and/or chopping and/or slicing the plant material into smaller pieces; contacting the smaller pieces with a pectinase activity and a rhamnogalacturonan acetyl esterase (RGAE) activity and clarifying the juice. Further contacting the said plant material with arabinanase activity is provided. In another aspect, use of combination of pectinase activity, RGAE activity and arabinanase activity in the production of juice from a plant material is described.

### FIELD OF THE INVENTION

The present invention relates to method of juice production. Particularly the present invention relates to a method of improving the mashing process in the production of juice from a plant material. More particularly the present invention relates to a method of improving the mashing process in the production of clarified juice from a plant material using enzymes.

### BACKGROUND OF THE INVENTION

The consumption of beverages made from juice extracted from plant material, particularly fruits and vegetables, has greatly increased in recent times due to technological breakthroughs in the juice processing and concentration industry. Better quality, better tasting and higher purity juice products which are more convenient to use have been developed. Juice consumers are interested in products that have an acceptable flavor, distinctive aroma, acceptable appearance and satisfactory mouth feel. Juice producers are, in addition, interested in improving juice yields, reduction of haze, improved filterability, improved clarity and improved pomace yield/appearance.

Technological advances in juice making machinery, particularly juice press and filtration equipment, have led to an increase in juice yields. Enzyme technologies and combinations of these with other technological advancements in juice making machinery have also been developed which increase juice yield, appearance and other parameters.

WO95/34223 discloses a method of producing cloud stable extracts such as juices from plant material by using one or more enzymes that attack the hairy regions of pectin.

There stills exists a need for processes that improve juice and/or beverage production from plant material.

### SUMMARY OF THE INVENTION

In one aspect, the invention relates to a method of improving the mashing process in the production of a clarified juice from a plant material comprising: (a) crushing and/or chopping and/or slicing the plant material into smaller pieces; (b) contacting the smaller pieces with a pectinase activity and a rhamnogalacturonan acetyl esterase (RGAE) activity; and (c) clarifying the juice.

In another aspect, the method further comprises contacting the plant material with an arabinanase activity.

In another aspect, the plant material is a vegetable or fruit.

In another aspect, the plant material is a fruit.

In one embodiment, the fruits are selected from, but not limited to, apples, pears, orange, lemon, lime, mandarin, tomatoes, grapes, black currants, red currants, raspberries, strawberries, cranberries, prunes, cherries, and pineapples.

In a preferred aspect, the fruit is an apple.

In another aspect, the plant material is a vegetable.

In one embodiment, the vegetables are selected from, but not limited to, carrots, celery and onions.

In one aspect, the juice is further processed into a beverage.

In one aspect, the improvement in the mashing process results in increased juice yield.

In another aspect, the juice yield is increased by 1% to 20%.

In one aspect, the improvement in the mashing process results in improved press capacity and/or improved filtration rate and /or reduced pomace moisture content.

In another aspect, the press capacity is improved by about 1.1 to about 3 fold compared to the control.

In one aspect, the filtration rate is increased to about 1.5 fold or 15%.

In another aspect, the moisture content of pomace is decreased by about 2% to 10%

In one aspect, pectinase activity is about 1 mg to 10 mg of enzyme protein (EP) per kg of the plant material.

In another aspect, rhamnogalacturonan acetyl esterase activity is about 0.2 to about 5 mg of enzyme protein (EP) per kg of the plant material.

In one aspect, arabinanase activity is about 2 to about 25 mg of enzyme protein (EP) per kg of the plant material.

In one aspect, the invention relates to the use of a combination comprising pectinase activity and rhamnogalacturonan acetyl esterase activity in the production of juice from a plant material.

In another aspect, the combination further comprises an arabinanase activity.

### DETAILED DESCRIPTION OF THE INVENTION

In one aspect, the present invention relates to a method of improving the mashing process in the production of juice from a plant material. More particularly, the present invention relates to a method of improving the mashing process in the production of juice from a plant material comprising: (a) providing a plant material (b) crushing and/or chopping and/or slicing the plant material into smaller pieces; (c) contacting the smaller pieces with a pectinase activity and a hemicellulase activity; and (d) obtaining the juice. In one aspect, the hemicellulase activity is an accessory enzyme activity. In one embodiment, the accessory enzyme activity is a rhamnogalacturonan acetyl esterase activity. More particularly, the present invention relates to a method of improving the mashing process in the production of clarified juice from a plant material comprising: (a) crushing and/or chopping and/or slicing the plant material into smaller pieces; (b) contacting the smaller pieces with a pectinase activity and a RGAE activity; and (c) clarifying the juice.

Juice is defined as the natural fluid, fluid content, or liquid part that can be extracted from a plant material.

Clarified juice is a juice wherein un-dissolved particulate matter has been removed. Clarification may be obtained by filtration and/or centrifugation and/or by using enzymes and/or by using fining agents like bentonite and gelatin or by other methods known in the art.

The plant material can be any part of the plant, including but not limited to fruits, vegetables, stem, leaves, roots, tuber, buds, flowers, shoot tip, root tip etc. Preferably, the plant material is rich in pectin. Pectin is known in the art. For example, see Voragen et al., 2003, Advances in pectin and pectinase research, Kluwer academic publishers, Netherlands.

Mashing, in general, refers to the process of conversion of the hard/semi-hard part of the plant material into a soft pulpy form in order to extract juice. Mashing may be accomplished using mechanical force to disrupt the cell wall or also by using enzymes to degrade the cell wall polymers or a combination of both.

A general process of juice making from plant material is outlined as follows: The plant material is washed and sorted and prepared for juice extraction by reducing it to a mash by a mashing process. Equipment, including but not limited to, grating equipment like a Ratz muhle (e.g., manufactured by Lauffer Company, in Horb, Germany) or smashing and cutting equipment like a hammer mill are used for mashing. Enzymes are also added before, during or after this process to aid mashing. The enzymes degrade the cell wall and other polymers found in the plant material and allow the juice to flow out. Once the mashing is over, the juice is pressed or separated from the non-soluble cell wall or tissue components by means of various presses, for example but not limited to, pneumatic press, hydraulic press, screw type press, screening centrifuge etc. Once the juice is extracted from the plant material, there is left behind an insoluble tissue structure called pomace. Optionally, pomace can be mixed with water and treated with enzymes for the total liquefaction of the remaining solid portions and further processed to extract additional juice. The juice is then optionally filtered, concentrated, sterilized and packed for further use. The process of crushing, chopping and slicing plant materials is generally known in the art. There are various equipments available for facilitating the same.

In one aspect the invention further comprises contacting the plant material with arabinanase activity. In one aspect, the plant material is obtainable from fruit and/or vegetable. In one embodiment, the plant material is obtainable from fruit. Fruit includes, but is not limited to, apples, pears, orange, lemon, lime, mandarin, tomatoes, grapes, black currants, red currants, raspberries, strawberries, cranberries, prunes, cherries, and pineapples. In another embodiment, the fruit is an apple.

In another aspect, the plant material is obtainable from vegetable. Vegetables include but not limited to, carrots, celery and onions, beetroots, radishes, horse-radishes, peas, beans, tomatoes, paprikas, cucumbers, and pumpkins; leaf and flower vegetables such as spinach, cabbage, and cauliflower.

In one aspect, the juice is further processed into a beverage before consumption. The further processing may involve blending, mixing or diluting with other materials. For example, two or more juices may be blended together into a beverage, or a juice may be used as a flavor agent in other beverages, for example, but not limited to, a beer, wine, wort etc. In one aspect, the juice is consumed as such. In such cases, the juice itself is the beverage.

In one aspect, the improvement in mashing is increased juice yield. In one aspect, the juice yield is increased by at least 1%, e.g., at least 2%, at least 3%, at least 4%, at least 5%, at least 10%, at least 15%, or at least 20% when compared to a control.

In another aspect, the improvement in mashing is due to increased Press Capacity. Press Capacity is defined as the time required to reach 65 to 70% yield during processing of 1 kg mash in a Hafico Press under standard conditions (1 kg mash at 25° C. under Hafico standard programme). The press capacity is generally measured as a fold increase over the control. Press Capacity (Fold increase) =Time taken by control/Time taken by treatment

In one aspect, the press capacity is increased by at least about 1.1%, e.g., at least about 1.2%, at least about 1.3%, at least about 1.4%, at least about 1.5%, at least about 1.6%, at least about 1.7%, at least about 1.8%, at least about 1.9%, at least about 2.0%, at least about 2.2%, at least about 2.4%, at least about 2.6%, at least about 2.8%, or at least about 3.0% over control.

In another aspect, the improvement is due to increased filtration rate. Filtration rate is a measure of the downstream performance of the juice obtained. It is a comparative measure whereby, the quantity of juice filtered by test sample is compared to the standard juice quantity filtered by control sample under same conditions. This is expressed as a fold increase over control. In one aspect, the filtration rate is increased by at least 1.1 fold, e.g., at least 1.1 fold, at least 1.2 fold, at least 1.3 fold, at least 1.4 fold, or at least 1.5 fold over control.

In one aspect, the improvement in mashing is due to reduced moisture content of the pomace. In one aspect, the moisture content is reduced by at least 2%, e.g., at least 3%, at least 4%, at least 5%, at least 6%, at least 7%, at least 8%, at least 9%, or at least 10% compared to a control. The moisture content is measured using many methods, for example, but not limited to, oven method, moisture meter method etc. preferably, the moisture content is measured using the oven method. A description of various methods is available in Ranganna, 1986, Handbook of analysis and quality control for fruit and vegetable products, pg 3-7,Tata McGraw-Hill Publishing company, New Delhi.

Moisture content (%)=(weight of moisture evaporated/weight of pomace before drying)*100

The moisture content of the pomace also influences its appearance. A pomace with low moisture content appears drier than a pomace with higher moisture content. A drier pomace is preferred for other applications including but not limited to feed making etc.

Pectinases are known in the art. They are enzymes that degrade pectic substances. There are different kinds of pectinases known including but not limited to:

### Polygalacturonase (EC 3.2.1.15)

Polygalacturonases are pectinases that catalyze random hydrolysis of (1,4)-alpha-D-galactosiduronic linkages in pectate and other galacturonans. They are also known as pectin depolymerase. Polygalacturonase hydrolyses the alpha-1,4-glycosidic bonds in polygalacturonic acid with the resultant release of galacturonic acid. This reducing sugar reacted then with 3,5-dinitrosalicylic acid (DNS). The colour change produced due to the reduction of DNS is proportional to the amount of galacturonic acid released, which in turn is proportional to the activity of polygalacturonase in the sample.

One polygalacturonase unit (PGNU) is defined as the amount of enzyme which will produce 1 mg of galacturonic acid sodium salt under standard conditions (acetate buffer, pH 4.5, 40° C., 10 min reaction time, 540 nm).

### Pectin Lyases (EC 4.2.2.10)

Pectin lyases are pectinases that catalyze eliminative cleavage of (1.4)-alpha-D-galacturonan methyl ester to give oligosaccharides with 4-deoxy-6-O-methyl-alpha-D-galact-4-enuronosyl groups at their non-reducing ends. They are alternatively known as pectolyase, polymethylgalacturonic transeliminase, pectin methyltranseliminase, pectin trans-eliminase, etc. The pectin lyase enzymatic reaction consists of splitting alpha-1-4 galacturonosidyl bonds producing unsaturated delta-4,5 uronide. The double bond with carbonyl function in C6 has an absorption in the UV. Optical density at 235 nm assays the pectin lyase activity.

One Pectin lyase (PL) unit is the quantity of enzyme that catalyses the split of bound endo alpha-1-4 galacturonosidyl (C6 Methyl ester) forming one micromole of delta-4,5 unsaturated product in one minute, according to described conditions of 45° C. and pH 5.5.

### Pectin Esterase (EC 3.1.1.11)

Pectin esterases are pectinases that hydrolyze pectin to methanol and pectate. They are alternatively known as pectin demethoxylase, pectin methoxylase, pectin methylesterase, etc. Pectin esterase catalyses the release of methanol from pectin with a resultant decrease in pH. Sodium hydroxide is added to maintain the pH at 4.5. The amount of sodium hydroxide consumed is an indication of the enzyme activity.

One unit of PE activity is that amount of enzyme which consumes 1 micro equivalent of sodium hydroxide per minute under standard conditions (30° C., pH 4.5).

The pectinase of the invention may comprise a single activity or at least two different activities.

In one aspect, pectinase activity is about 1.0 mg to about 10 mg of enzyme protein (EP) per kg of the plant material, e.g., about 1.0 mg to about 8 mg of enzyme protein, about 1.0 mg to about 6 mg of enzyme protein, about 1.2 mg to about 4 mg of enzyme protein, about 1.5 mg to about 3 mg of enzyme protein, about 1.6 mg to about 2.6 mg of enzyme protein, or about 1.9 to 2.1 mg of enzyme protein per kg of the plant material.

Pectinases of the invention may be obtained by fermentation of organisms. Fermentation of organisms to produce enzymes is known in the art. There are different kinds of fermentation including but not limited to submerged fermentation (SmF) and surface fermentation (SSF).Submerged fermentation (SmF) is known in the art and includes a process of growing a microorganism in a liquid medium. Submerged Fermentation is also alternatively known as Submerged Liquid Fermentation or submerse fermentation Surface fermentation also called solid-state fermentation (SSF) is known in the art and is a process whereby an insoluble substrate or solid matrix is fermented with sufficient moisture but without being submerged in water. i.e., it involves growth of microorganisms on moist solid particles, in situations in which the spaces between the particles contain a continuous gas phase and a minimum of visible water. It is also known as Solid Substrate Fermentation. Most of the SSF processes are aerobic and so the term fermentation in the context of SSF is meant to mean the “controlled cultivation of organisms”. Processes and apparatus for solid state fermentation are known in the art. For example, a useful reference is Mitchell D.A. et al., 2006, Solid-State Fermentation Bioreactors, published by Springer Berlin Heidelberg.

In one aspect, the pectinase is obtained from a non-genetically modified organism. In another aspect, the pectinase is obtained from a genetically modified organism. Pectinase producing organisms are known in the art. They include microorganisms and higher plants. The microorganisms include bacteria, yeast and fungi. For example, Aspergillus, Rhizopus, Bacillus, Pseudomonas, Fusarium, Penicillium, Saccharomyces, Erwinia etc., are all known to produce pectinase enzymes. The procedures for carrying out the submerged and solid state fermentations for many of these organisms are well known in the art.

In one aspect of the invention, pectinase is obtainable from Aspergillus. The term “obtainable from” as used herein in connection with a given source shall mean that the polypeptide encoded by the nucleic acid sequence is produced by the source or by a recombinant cell (also called a host cell) in which the nucleic acid sequence from the source is present. In a preferred embodiment, the polypeptide is secreted extracellularly. In another preferred embodiment, the polypeptide is intracellular.

Depending upon the host employed in a recombinant production procedure, the enzymes of the present invention may be glycosylated or may be non-glycosylated. In addition, the enzymes of the invention may also include an initial modified methionine residue, in some cases as a result of host-mediated processes.

Aspergillus is known in the art. It is a genus of Fungi belonging to the Trichocomaceae family of the order Eurotiales [Howard, H D, Pathogenic Fungi in Humans and Animals, 2nd edition Pathogenic Fungi in Humans and Animals, pp 240]. Sterigmatocystis is an obsolete synonym of this genus. More than 150 species of the genus Aspergillus are known in the art. These include but not limited to Aspergillus niger, Aspergillus flavus, Aspergillus fumigatus, Aspergillus otyzae, Aspergillus japonicus, Aspergillus aculeatus etc. In a preferred embodiment, the pectinase is obtainable from Aspergillus niger. In another preferred embodiment, they are obtainable from Aspergillus aculeatus. In another preferred embodiment, they are obtainable from Aspergillus japonicus.

Hemicelluloses are complex, branched carbohydrate polymers of arabinose, mannose, glucose and xylose attached through different linkages. Substituents and noncarbohydrate components occur on hemicelluloses on either the main chain or on the carbohydrate branches. Hemicellulases are a diverse group of O-glycosyl hydrolases that degrade hemicelluloses.

Hemicellulases are generally classified into three categories:
1. Endo-acting enzymes that attack the polysaccharide chains internally with very little activity on short oligomers. Examples of endo-acting hemicellulases include, but are not limited to, endoarabinanase [3.2.1.99], endoglucanase [3.2.1.4], endomannanase [3.2.1.78], endoxylanase, etc.
2. Exo-acting enzymes that act processively from either the reducing or non-reducing termini. Examples of exo-acting hemicellulases include, but are not limited to, alpha-arabinosidase [3.2.1.55], beta-arabinosidase[3.2.1.88], galactosidases, glucosidases, mannosidases, xylosidases, etc.
3. Accessory enzymes required to hydrolyse hemicellulose in the native plant tissue. This category includes a variety of acetylesterases and arylesterases. Examples of accessory enzymes include, but are not limited to, acetylgalactan esterase, acetlymannanesterase, acetylxylan esterase, rhamnogalacturonan acetyl esterase, courmaric acid esterase, ferulic acid esterase, etc.
   A review of hemicellulases and their classification is available in Brigham et al., 1996 Hemicellulases: Diversity and applications in Handbook on bioethanol: Production and utilization edited by Charles Wyman, Applied Energy Technology series published by Taylor and Francis, Washington D.C., USA., 119-142, incorporated herein by reference.

### Arabinanases:

### Endoarabinanases (EC 3.2.1.99).

Endoarabinanases are endo-acting hemicellulases that catalyze the endohydrolysis of (1,5)-alpha-arabinofuranosidic linkages in (1,5)-arabinans. They are alternatively known as arabinan endo-1,5-alpha-L-arabinosidase or endo-1,5-alpha-L-arabinanase. Arabinanase is assayed using the substrate azurine-crosslinked-debranched arabinan (AZCL-Arabinan), commercially available as Arabinazyme™ tablets (available from Megazyme International, Ireland Ltd, Wicklow, Ireland).

One unit of endoarabinanase activity is defined as the amount of enzyme required to release 1 micromole of arabinose reducing sugar equivalents from Carboxy Methyl (CM)-linear arabinan per minute under the defined assay conditions (40° C., pH 4.0).

### Exoarabinanases (EC 3.2.1._)

Exoarabinanases are exo-acting hemicellulases that catalyze the hydrolysis of terminal non-reducing alpha-L-arabinofuranoside residues in alpha-L-arabinosides. There are different kinds of exoarabinanases, for example, but not limited to, EC 3.2.1.55.

In one aspect, arabinanase activity is about 2.0 to 25.0 mg of enzyme protein (EP) per kg of the plant material, e.g., about 20 to 20.0 mg of enzyme protein, about 20 to 15.0 mg of enzyme protein, about 3.0 to 10.0 mg of enzyme protein, about 4.0 to 8.0 mg of enzyme protein, about 5.0 to 7.0 mg of enzyme protein, or about 5.0 to 6.0 mg of enzyme protein per kg of the plant material. In one aspect, the arabinanase is obtainable from Aspergillus. In a preferred aspect, the arabinanase is obtainable from Aspergillus aculeatus.

Rhamnogalacturonan Acetyl Esterase (RGAE; EC 3.1.1.6)

Rhamnogalacturonan acetyl esterase is an accessory hemicellulase which catalyzes the deacetylation of rhamnogalacturonan I, which is one of the most complex pectic polysaccharides present in the wall of higher plants. The polysaccharide rhamnogalacturonan I is composed of alternating rhamnose and galacturonic acid residues. The latter can have acetylations at the C-2 and C-3 positions, and the removal of such acetyl groups facilitates the action of lyases and hydrolases, since the acetylation sterically hinders the cleavage of the glycosyl linkages

In one aspect, the rhamnogalacturonan acetyl esterase is obtainable from Aspergillus. In a preferred aspect, the rhamnogalacturonan acetyl esterase is obtainable from Aspergillus aculeatus. In another aspect, the rhamnogalacturonan acetyl esterase is the one disclosed in Kauppinen et al., 1995, J. Biol Chem., 270, 27172-27178.

In another aspect, rhamnogalacturonan acetyl esterase activity is about 0.1 to about 5.0 mg of enzyme protein (EP) per kg of the plant material, e.g., about 0.2 to 4.0 mg of enzyme protein, about 0.3 to 3.0 mg of enzyme protein, about 0.4 to 2.0 mg of enzyme protein, about 0.5 to 1.0 mg of enzyme protein (EP), or about 0.6 to 0.9 mg of enzyme protein per kg of the plant material.

The enzymes may also be obtained from the organism by use of recombinant DNA techniques known in the art (c. f. Sambrook, J. et al., 1989, Molecular Cloning, A Laboratory Manual, Cold Spring Harbor Press, Cold Spring Harbor, N.Y., USA). The use of recombinant DNA techniques generally comprises cultivation of a host cell transformed with a recombinant DNA vector, consisting of the product gene of interest inserted between an appropriate promoter and terminator, in a culture medium under conditions permitting the expression of the enzyme and recovering the enzyme from the culture. The DNA sequence may be of genomic, cDNA or synthetic origin or any combination of these, and may be isolated or synthesized in accordance with methods known in the art.

In the production methods of the present invention, the cells are cultivated in a nutrient medium suitable for production of enzyme using methods known in the art. For example, the cell may be cultivated by shake flask cultivation, small-scale or large-scale fermentation (including continuous, batch, fed-batch, or solid state fermentations) in laboratory or industrial fermentors performed in a suitable medium and under conditions allowing the polypeptide to be expressed and/or isolated. The cultivation takes place in a suitable nutrient medium comprising carbon and nitrogen sources and inorganic salts, using procedures known in the art. Suitable media are available from commercial suppliers or may be prepared according to published compositions (e.g., in catalogues of the American Type Culture Collection). If the enzyme is secreted into the nutrient medium, it can be recovered directly from the medium. If the enzyme is not secreted, it can be recovered from cell lysates.

The resulting enzymes may be recovered by methods known in the art. For example, the enzymes may be recovered from the nutrient medium by conventional procedures including, but not limited to, centrifugation, filtration, extraction, spray-drying, evaporation, or precipitation.

The enzymes of the present invention may be purified by a variety of procedures known in the art including, but not limited to, chromatography (e.g., ion exchange, affinity, hydrophobic, chromatofocusing, and size exclusion), electrophoretic procedures (e.g., preparative isoelectric focusing), differential solubility (e.g., ammonium sulfate precipitation), SDS-PAGE, or extraction (see, e.g., Protein Purification, J.-C. Janson and Lars Ryden, editors, VCH Publishers, New York, 1989).

An enzyme activity to be used according to the invention is preferably purified. The term “purified” as used herein covers enzyme protein preparations where the preparation has been enriched for the enzyme protein in question. Such enrichment could for instance be: the removal of the cells of the organism from which an enzyme protein was produced, the removal of non-protein material by a protein specific precipitation or the use of a chromatographic procedure where the enzyme protein in question is selectively adsorbed and eluted from a chromatographic matrix. The enzyme may have been purified to an extent so that only minor amounts of other proteins are present. The expression “other proteins” relates in particular to other enzymes. An enzyme to be used in the method of the invention may be “substantially pure”, i.e. substantially free from other components from the organism in which it was produced, which may either be a naturally occurring microorganism or a genetically modified host microorganism for recombinant production of the enzyme. However, for the uses according to the invention, the enzyme need not be that pure. It may, e.g., include other enzymes.

The enzymes may be added as enzyme compositions. They may consist of one enzyme or more than one enzyme. The enzyme composition, in addition to the enzyme(s), may also contain at least one other substance, for example, but not limited to, buffer, surfactants, etc. The enzyme compositions may be in any art-recognized form, for example, solid, liquid, emulsion, gel, or paste. Such forms are known to the person skilled in the art. In one aspect of the invention, more than one enzyme composition, each containing different enzymes may be added. In another aspect of the invention, one enzyme composition containing all the necessary enzymes may be added. In yet another aspect of the invention, one enzyme composition containing a few of the enzymes and at least one another composition containing some or all of the rest of the enzymes may be added. The enzymes may be added to the mash at any point of time between the first crushing/chopping/slicing and the final filtration. The enzymes may be added at the same time or in sequence one after another or even as a combination of two enzymes and one enzyme separately, one after the other.

The contacting must be performed under conditions allowing the pectinase activity, rhamnogalacturonan acetyl esterase activity and arabinanase activity to cleave the pectin substance in the plant material. Such conditions include, but are not limited to, temperature, pH and reaction/incubation time.

The contacting is performed at a temperature depending on the optimum temperature for the enzyme and also the stage at which the enzyme is added. The skilled person would know how to determine the optimum temperature for the enzyme. For purposes of this invention the contacting is performed generally in the range of about 5° C. to about 45° C., e.g., about 5° C. to about 40° C., about 10° C. to about 35° C., or about 10° C. to about 30° C.

The contacting is performed at a pH depending on the optimum pH for the enzyme and also the stage at which the enzyme is added. The skilled person would know how to calculate the optimum pH for the enzyme. For purposes of this invention the contacting is performed at a pH generally in the range of about 2.0 to about 7.0, e.g., about 2.0 to about 6.0, about 2.0 to about 5.5, about 2.0 to about 5.0, or about 2.5 to about 4.5.

In one aspect, the contacting is performed for a period between 10 minutes and 5 hours, e.g., between 10 minutes and 4 hours, between 10 minutes and 180 minutes, between 10 minutes and 120 minutes, or between 30 minutes and 90 minutes.

The juice obtained is optionally subjected to filtration. Filtration of the juice extract may be performed using well known techniques. Filtration is the process of separation of the undissolved particulate matter from the rest of the suspension by passing the suspension through a filter or a series of filters. Filtration can be considered a type of clarification process. Filterability is a property of a solution or suspension, which makes it amenable to filtration. Membrane filtration uses membranes made of, for example, polycarbonate, polysulfone or even polypropylene of varying pore sizes to remove suspended particles. Ultra membrane filtration and sterile membrane filtration use membranes of very small pore size to remove microorganisms. Cross flow filtration is a type of filtration in which the fluid to be filtered passes rapidly across the filter surface, with only a fraction permeating through the membrane as filtrate. This type of filtration is different from the traditional perpendicular flow filtration method which involves all of the fluid passing through the filter medium.

The juice filtrate is then optionally concentrated using known methods and then sterilized using known methods and packed.

In one aspect, the invention relates to the use of a combination of pectinase activity and rhamnogalacturonan acetyl esterase activity in the production of juice from a plant material.

In another aspect, the combination further comprises an arabinanase activity

The invention is further illustrated in the following examples, which are not intended to be in any way limiting to the scope of the invention as claimed.

### Examples

### Materials and Methods

Apples belonging to Granny Smith and Chinese Fuji variety were commercially obtained. All other chemicals and reagents used were of commercial grade.

### Equilibration of Apples

Apples were generally stored at 4° C. to maintain the freshness.

### Grating/Milling of Apples

When required, the apples were equilibrated at approximately 23° C. and milled using a kitchen grater or a Voran mill to obtain a mash of the desired size. The treated mash was subjected to the desired application conditions.

### Preliminary Analysis of Juice

A part of the grated mash was filtered on a 14 LS (4.4 μ) Whatman™ filter paper. The juice was evaluated for starch content, pH and Brix.

Distribution of the Mash into Aliquots

The bulk mash was mixed properly to ensure homogeneity of sample before it was aliquoted into tared plastic beakers/containers for mashing trials. One kg of mash was aliquoted and equilibrated to the desired temperature (23° C.) in a water bath.

### Enzymatic Mashing

To 1 kg of the mash pre-equilibrated to 23° C., a specific dose of enzyme was added. To achieve a required dose, a calculated volume of enzyme/enzymes (alone or combinations) was added to the mash. The enzyme dilutions were made in water. The mash was mixed with a spatula on addition of the enzyme and allowed to stand over a period of 1 hour. The pectinases used were Neopectinase PL1® (available from Novozymes A/S Denmark) and Rohapect® (Available from AB enzymes, Germany).

The rhamnogalacturonan acetyl esterase (RGAE) was obtained as disclosed in Kauppinen et al., 1995 J. Biol Chem., 270, 27172-27178. The pectin esterase used was Novoshape (available from Novozymes A/S Denmark). The rhamnogalacturonase II (RG2), an enzyme that attacks the backbone of hairy regions of pectins, was obtained as described in WO92/19728. The arabinanase was obtained as described in Skjot et al., 2001, Mol Genet Genomics, 265:913-921.

### Juice Extraction in Laboratory Press

The juice was extracted from the mash using a laboratory press, Hafico HP-5M-VA-T (Fischer Maschinenfabrik, Germany), which employs a stainless steel strainer and a nylon cloth. The nylon cloth was folded in a specific manner in the strainer and the mash was added into the cloth. The free run juice was noted down [i.e. recorded]. for 1 minute period. The cloth was then folded in a systematic manner and a lid was placed over the cloth. After 2 minutes, the system was started. The pressing was performed at the following set program:

| PRESS PROCEDURE | PRESSURE Kg/m3 | RUN TIME |
|---|---|---|
| step 1 (press start) | 16 bar | 1 min. |
| step 2 | 30 bar | 1 min. |
| step 3 | 45 bar | 1 min. |
| step 4 | 60 bar | 1 min. |
| step 5 | 85 bar | 1 min. |
| step 6 | 100 bar | 1 min. |
| step 7 | 200 bar | 1 min. |
| step 8 | 300 bar | 1 min. |
| Press should be stopped manually | | |
| Step 9 | 300 bar | 1 min. |

0-1 min: fill mash into press and note the free run juice
1-2 min: Prepare Hafico, place lid
arabinosidase 3rd min: turn on press
After 3, 4, 5, 6, 7, 8, 9, 10 minute read juice yield
Stop the press manually at 10th minute.

The final weight of the juice collected during the run and the exact time required for attaining 70% juice yield (700 gm juice from 1000 gm mash) were measured. The pomaces along with the cloth were then weighed. The pomace was checked for wetness/moisture content and left overnight to dry. The juice obtained was taken up for determination of a variety of parameters like juice yield, moisture content, turbidity, press capacity, filtration rate, some without centrifugation and some with centrifugation.

### Analysis on Un-Centrifuged Juice

The juice obtained was taken up as such without centrifugation for determination of Brix, pH, turbidity and sedimentation behaviour.

### Analysis on Centrifuged Juice

Around 20 ml of juice was centrifuged at 4000 rpm for 5 minutes or alternatively at 5200 rpm (2119 g) for 10 minutes at ambient temperature. The supernatant was used for determination of Brix, turbidity after, viscosity, and pectin content.

### Determination of Juice Yield

The juice collected at the end of 10^{th} minute was recorded. Since the exact weight of the mash taken for pressing was known, the % juice yield was calculated as follows:

$$\% juice yield = ( \frac{wt of juice}{wt of the mash} ) * 100$$

### Evaluation of Pomace for Moisture Content

The pomace was broken up and checked physically for its wetness and mash structure whether intact or disrupted. In addition, the moisture content of the pomace was determined with the help of a moisture meter and/or by the oven drying method described below:

A known amount of pomace was weighed on a Petri plate of known weight (W1). The weight of the plate with the pomace was determined (W2 and then was allowed to stand in an oven at 105° C. overnight. The weight of the Petri plate with pomace was determined (W3). The % moisture was calculated as follows:

$$\% moisture = \frac{W 2 - W 3}{W 2 - W 1} * 100$$

The pomaces obtained by different treatments were also compared visually to each other and also to the control. The visual appearance of the dryness of the pomace was also recorded.

### Determination of Turbidity

Turbidity of the centrifuged and un-centrifuged juice samples was determined with a TURBIQUANT 3000 TURBIDITYMETER (Merck Ltd., India) in terms of EBC (European Brewery Convention) and/or Nephelometric Turbidity Units (NTU).

### Determination of Cloud Stability

Cloud stability was determined as described in WO95/34223. More specifically the method is based upon a centrifugation of a 60 ml extract sample in a glass centrifuge tube and centrifuged for 15 min at 4160×g. The turbidity before (To) and after centrifugation (Tz) is measured by a Nephla Turbidity Photometer conforming to DIN 38404 and ISO 7027 using a formazin DIN standard. The cloud stability (delta T_{z})(%) is then calculated as:

ΔT_{z}(%)=[(T_{z})/(T₀)]×100.

### Determination of Press Capacity

The exact time required for attaining 70% juice yield or alternatively 60% juice yield was used as a means of evaluating the press capacity. The less time required to attain 70% or 60% juice yield, the better was the press capacity of the mash, thus realizing faster processing.

### Determination of Filtration Rate of Juice Extract

The mashing enzymes were evaluated on the basis of downstream performance of the juice obtained in a dead end filtration or alternatively ultrafiltration.

### Dead End Filtration:

The filtration trails were carried out in a Laffort wine filtration unit using Whatman™ Filter paper.

### Ultrafiltration:

The filtration trials were carried out in a fabricated Ultrafiltration system [Pall India] using a 50 nm tubular ceramic membrane with a channel diameter of 7 mm and length of 250 mm with filtration area of 50 cm². The flux rate was measured over a period of 100 minutes and reported

### Example 1

The effect of addition of a RGAE to a pectinase in terms of improvement in mashing properties is given in table below. The pectinase used was Neopectinase PL1™, a pectinase obtained from a non-genetically modified organism. The effect was also compared to a combination of pectinase and pectin esterase

| | | Pectinase + | | Pectinase + | |
|---|---|---|---|---|---|
| | Pectinase | pectin esterase | | RGAE | |
| | (PL1) | (PL1 + PE) | | (PL1 + RGAE) | |
| Dosage | 25 | 25 + 6.5 | 25 + 11 | 25 + 6.5 | 25 + 11 |
| (ppm) | | | | | |
| Yield % | 72.1 | 72.8 | 73 | 73.5 | 74.2 |
| % increase in | 0 | 0.97 | 1.25 | 1.94 | 2.91 |
| yield over | | | | | |
| control | | | | | |
| (pectinase) | | | | | |
| Press | 9.00 | 8 | 8 | 8 | 7 |
| capacity | | | | | |
| (in time) | | | | | |
| 70% | 4667 | 5250 | 5250 | 5250 | 6000 |
| Processed | | | | | |
| Juice per | | | | | |
| hour | | | | | |
| Press | 1.00 | 1.12 | 1.12 | 1.12 | 1.29 |
| capacity (fold) | | | | | |
| over control | | | | | |
| (pectinase) | | | | | |
| Filtration rate | 18.4 | 12.7 | 13.06 | 23.61 | 27.44 |
| in gms-5 min | | | | | |
| Filtration rate | 1.0 | 0.7 | 0.7 | 1.3 | 1.5 |
| (fold) over | | | | | |
| control | | | | | |
| pomace % M | | | | | |

The results above demonstrated that a combination of pectinase and an RGAE improved the mashing properties compared to a combination of pectinase and pectin esterase or a pectinase alone.

### Example 2

The effect of addition of an RGAE to Rohapect®, a pectinase obtained from a genetically modified organism, is given below:

| | Pectinase | Pectinase + RGAE | |
|---|---|---|---|
| Dosage (ppm) | 25 | 25 + 10 | 25 + 5 |
| Yield % | 73.3 | 76.3 | 75.2 |
| % increase in yield over | 0 | 4.09 | 2.59 |
| control (pectinase) | | | |
| Press capacity (in | 8 | 7 | 7 |
| time)[minutes] | | | |
| Pressability (fold) over | 1 | 1.14 | 1.14 |
| control (pectinase) | | | |
| Flux rate in gms | | | |
| Flux rate/hr | | | |
| pomace % M | 78.4 | 71.98 | 75.77 |
| Dry matter % | 21.6 | 28.02 | 24.23 |
| % Decrease in Moisture | 0 | 6.42 | 2.63 |

The results above demonstrated that a combination of pectinase and an RGAE improved the mashing properties compared to a combination of pectinase and pectin esterase or a pectinase alone.

### Example 3

The effect of addition of a RGAE to a pectinase (Neopectinase PL1™) in terms of improvement in mashing properties is given in table below. It was also compared to a combination of the pectinase with rhamnogalacturonase (RG2), a combination of pectinase with RGAE and RG2 and a pectinase with RGAE and endo and exo arabinanase.

| | | PL1 + R | PL1 + RG | PL1 + RGAE + | PL1 + RGAE + ENDO + |
|---|---|---|---|---|---|
| | PL1 | GAE | 2 | RG2 | EXO arabinanase. |
| Dosage (ppm) | 25 | 25 + 1 | 25 + 1 | 25 + 1 + 1 | 25 + 1 + 1 + 1 |
| Yield % | 70.79 | 71.49 | 70.97 | 71.74 | 72.31 |
| % increase in yield over | 0 | 0.99 | 0.25 | 1.34 | 2.15 |
| control (pectinase PL1) | | | | | |
| Press capacity | 8.42 | 8.06 | 8.09 | 7.82 | 7.46 |
| (in time) [minutes] | | | | | |
| 70% Processed Juice per | 4988 | 5211 | 5192 | 5371 | 5630 |
| hour | | | | | |
| Press capacity (fold) over | 1.00 | 1.04 | 1.04 | 1.08 | 1.13 |
| control ((pectinase PL1)) | | | | | |
| UltraFiltration flux rate | 4 | 4.6 | 4.6 | 3.7 | 4.6 |
| (L/sqm/h) at 100^{th} min | | | | | |
| Filtration rate | 1 | 1.15 | 1.15 | 0.93 | 1.15 |
| (fold) over control | | | | | |
| (pectinase PL1) | | | | | |
| pomace % Moisture | 80.6 | 77.28 | 78.28 | 78.03 | 77.58 |
| Delta Tz (cloud stability) | 3.69 | 0.83 | 2.27 | 2.64 | 2.95 |

From the table above, it is apparent that a combination of pectinase with RGAE results in increased yield, increased press capacity, increased flux rate, decreased cloud stability and decreased pomace moisture content (increased pomace dryness) as compared to pectinase alone. Addition of RG2 increases the cloud stability.

### Example 4

The effect of addition of a RGAE to a pectinase (Neopectinase PL1™) in terms of improvement in mashing properties is given in table below. It was also compared to a combination of the pectinase with rhamnogalacturonase (RG2) and a combination of pectinase with RGAE and RG2. The apples used were Granny Smith apples.

| | CONTROL | RG2 | RGAE | RG2 + RGAE | PL1 + RG2 | PL1 + RGAE | PL1 + RG2 + RGAE |
|---|---|---|---|---|---|---|---|
| Dosage (ppm) | 0 | 1 | 1 | 1 + 1 | 25 + 1 | 25 + 1 | 25 + 1 + 1 |
| Yield % | 59.73 | 60.71 | 61.05 | 62.88 | 70.09 | 70.24 | 70.01 |
| % increase in | 0.00 | 1.64 | 2.21 | 5.27 | 17.34 | 17.60 | 17.21 |
| yield over | | | | | | | |
| control (no | | | | | | | |
| enzyme) | | | | | | | |
| Press capacity | 9.49 | 8.8 | 8.55 | 7.3 | 4.02 | 4.26 | 4.03 |
| (60% | | | | | | | |
| (in time) | | | | | | | |
| 60% Processed | 3793 | 4091 | 4211 | 4932 | 8955 | 8451 | 8933 |
| Juice per hour | | | | | | | |
| Press | 1.00 | 1.08 | 1.11 | 1.30 | 2.36 | 2.23 | 2.35 |
| capacity(fold) | | | | | | | |
| over control (no | | | | | | | |
| enzyme) | | | | | | | |
| Dead end | nd | 31 | 34 | 30 | 65 | 87 | 58 |
| Filtration | | | | | | | |
| (amount in | | | | | | | |
| gms-10 min) | | | | | | | |
| Filtration rate | nd | nd | nd | nd | nd | nd | nd |
| (fold) over | | | | | | | |
| control (no | | | | | | | |
| enzyme) | | | | | | | |
| pomace | wet | wet | dry | dry | drier | driest | driest |
| appearance | | | | | | | |
| Delta T_{z} (cloud | 63.72 | 76.54 | 74.26 | 58.03 | 14.61 | 8.54 | 3.55 |
| stability) | | | | | | | |

Note:
nd = not determined

From the table above, it is apparent that a combination of pectinase with RGAE results in increased yield, increased press capacity, increased flux rate, decreased cloud stability and decreased pomace moisture content (increased pomace dryness) as compared to RG2 alone, RGAE alone or a combination of RG2 and RGAE alone.

1-17. (canceled)

18. A method of improving the mashing process in the production of clarified juice from a plant material comprising:
a) crushing and/or chopping and/or slicing the plant material into smaller pieces;
b) contacting the smaller pieces with a pectinase activity and a rhamnogalacturonan acetyl esterase (RGAE) activity; and
c) clarifying the juice.

19. The method of claim 18, further comprising contacting the plant material with an arabinanase activity.

20. The method of claim 18, wherein the pectinase is obtainable from Aspergillus,

21. The method of claim 18, wherein the pectinase is obtainable from Aspergillus niger or Aspergillus aculeatus.

22. The method of claim 18, wherein the plant material is obtainable from vegetables and/or fruits.

23. The method of claim 22, wherein the fruits are selected from the group consisting of apples, pears, orange, lemon, lime, mandarin, tomatoes, grapes, black currants, red currants, raspberries, strawberries, cranberries, prunes, cherries, and pineapples.

24. The method of claim 23, wherein the fruits are apples.

25. The method of claim 22, wherein the vegetables are selected from the group consisting of carrots, celery and onions.

26. The method of claim 18, wherein the improvement is increased juice yield.

27. The method of claim 18, wherein the improvement is increased pomace dryness.

28. The method of claim 18, wherein the improvement is increased press capacity.

29. The method of claim 18, wherein the improvement is increased flux rate.

30. The method of claim 18, wherein the juice is further processed into a beverage.

31. The method of claim 18, wherein the pectinase activity is about 1.0 to about 10.0 mg of enzyme protein (EP) per kg of the plant material.

32. The method of claim 18, wherein the rhamnogalacturonan acetyl esterase activity is about 0.1 to about 5.0 mg of enzyme protein (EP) per kg of the plant material.

33. The method of claim 18, wherein the arabinanase activity is about 2.0 to about 25.0 mg of enzyme protein (EP) per kg of the plant material.
